(19) United States
(12) Patent Application Publication
(10) Pub. No.: US 2006/0180426 A1
(43) Pub. Date: Aug. 17, 2006

(54) Conveyor roller assembly

(76) Inventor: C. Winfield Scott, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/047,099

(22) Filed: Jan. 31, 2005

(51) Int. Cl. B65G 13/00

(52) U.S. Cl. 193/37

(57) ABSTRACT

A reduced noise conveyor roller assembly having an elongate roller tube, a pair of stub axles rotationally supported within opposite ends of the roller tube so that the roller tube is rotatable with respect to the stub axles, and a sound-absorptive material located within the roller tube. A method of forming a reduced noise conveyor roller assembly is also provided.

### FIELD OF THE INVENTION

The present invention relates to the field of conveyor rollers and, more particularly, to stub axle conveyor rollers which exhibit reduced noise during use.

### BACKGROUND OF THE INVENTION

Conveyor systems utilizing rollers are widely used in a variety of industrial applications. In a typical configuration, a plurality of closely spaced, freely-rotating conveyor rollers are mounted in parallel to an elongate support frame. The structure for mounting the rollers to the support frame is integral with the rollers. In some conveyor roller designs, inserts are mounted in each end of the roller tube and include protrusions projecting outwardly from the ends of the tube which are received within opposing pairs of mounting holes provided on the conveyor frame. Consequently, each conveyor roller assembly is independently attachable to and removable from the conveyor support frame.

A significant concern with existing conveyor rollers is the amount of noise which they generate. In many installations such as manufacturing facilities and warehouses, hundreds, or even thousands, of conveyor rollers may be utilized. As a conventional conveyor roller rotates in its frame, a considerable amount of noise is generated. In large installations having thousands of conveyor rollers, the noise level can be such as to require workers in the area to wear hearing protection. Thus, not only does conveyor roller noise result in inconveniences to those working in the general vicinity, it is also a significant health and safety concern.

Conveyor roller noise is a result of several factors. For example, faulty or worn out bearings can generate significant noise as the conveyor roller rotates. Perhaps more significantly, vibration of the conveyor roller assembly with respect to the support frame also generates significant amounts of noise.

By way of example, and as mentioned previously, some conveyor roller designs utilize inserts mounted within each end of the roller tube, and these inserts include protrusions which project outwardly from the ends of the tube. These protrusions are received within opposing pairs of mounting holes provided on the conveyor frame. Such a structure is advantageous in terms of flexibility of design and ease of maintenance. However, a disadvantage with such a conveyor rollers is that a loose fit between the protrusions and the mounting holes can enlarge due to wear over time to the point where the protrusions may rotate in their respective mounting holes, resulting in further wear and noise. This is especially true for roller bodies having cylindrical protrusions or for rollers bearing high loads. In order to avoid this problem, rollers have been designed using non-cylindrical protrusion shapes to prevent their rotation relative to the support frame.

Typically, these protrusions have a polygonal shape in cross section, such as a hexagonal shape. However, other shapes, such as semi-cylindrical, having a flat formed thereon, have been used. For example, U.S. Pat. No. 3,353,644 to McNash et al. discloses a conveyor roller having protruding hexagonal stub shafts for engaging correspondingly-shaped mounting holes in side rails. However, even when rollers having protrusions with eccentric shapes are used, some wear and noise results during use due to the continual vibration of the conveyor assembly. Furthermore, over time, the edges of the protrusions and the mounting holes or slots can wear to the point where rotation of the protrusion in the hole becomes possible, further adding to the wear on, and early failure of, the rollers. The repair work that is required to maintain these systems, especially when conveyor rollers wear out and fail prematurely, can be quite expensive both in labor and materials and production downtime.

To prevent this occurrence, prior art systems have used protrusions which are spring-biased and tapered so that they fit snugly into the mounting holes or slots of the conveyor frame. An example of such a configuration is shown in U.S. Pat. No. 5,865,290 (which is incorporated herein by reference).

Recently, conveyor rollers having softer protrusions have been developed. For example, Applicant's U.S. patent application Ser. No. 10/817,185, filed on Apr. 2, 2004 (which is incorporated herein by way of reference), discloses a conveyor roller insert wherein the outer end portion of the protrusion (or axle) has a surface hardness which is less than that of the inner portion of the axle. In one embodiment, a polymeric, removable end cap is secured on an outer tip portion of the axle. Since this polymeric end cap is positioned within the mounting hole of the conveyor frame rather than the metal portion of the axle, vibration and noise is significantly reduced (along with reduced wear of the mounting holes of the conveyor frame).

In spite of the above, there is still a need for conveyor rollers having reduced noise.

### SUMMARY OF THE INVENTION

One embodiment of the present invention provides a conveyor roller assembly comprising:

(a) an elongate roller tube;

(b) a pair of stub axles rotationally supported within opposite ends of the roller tube such that the roller tube is rotatable with respect to the stub axles; and

(c) a sound-absorptive material located within the roller tube.

The roller tube may comprise a rigid, self-supporting cylinder, and may be straight, tapered (in whole or in part) or even crowned.

Each of the stub axles may be provided as part of a roller insert, with the roller inserts inserted into opposite ends of the roller tube. In addition to a stub axle, each of the roller inserts may also include a cartridge having configured to be inserted into an end of the conveyor roller tube, and at least one bearing mounted within the cartridge and supporting the axle within the cartridge such that the cartridge is rotatable with respect to the axle and the outer end of each of the stub axles projects outwardly away from the outer end of its corresponding cartridge. The axles may also be slidable with respect to the bearing(s), and one or both stubs axles of the conveyor roller assembly may be biased outwardly from its corresponding cartridge.

The interior of the roller tube between the roller inserts (e.g., between the inner ends of the stub axles) may be substantially filled by the sound-absorptive material. For example, the sound-absorptive material may comprise a cylindrical mass (straight or tapered cylinder), and the end walls of the cylindrical mass may be located immediately adjacent to the innermost portion of the roller inserts (e.g., immediately adjacent to the inner ends of the stub axles). In one embodiment, the sound-absorptive material comprises a cylindrical mass (straight or tapered cylinder) having an outer diameter which is equal to or greater than the interior diameter of the roller tube. This cylindrical mass may be compressed within the roller tube such that the cylindrical mass exerts an outward force against the interior wall of the roller tube. Not only will this improve sound absorption, it will also ensure that the cylindrical mass rotates with the roller tube during use. In one embodiment, the sound-absorptive material comprises expanded polystyrene foam.

A method of forming a conveyor roller assembly is also provided, and comprises:

(a) providing an elongate roller tube comprising a rigid, self-supporting cylinder having first and second open end portions;

(b) providing a pair of roller inserts, each of the roller inserts comprising:
a stub axle having inner and outer ends;
a cartridge having inner and outer ends, the stub axle positioned within the cartridge; and
at least one bearing mounted within the cartridge and supporting the axle such that the cartridge is rotatable with respect to the axle;

wherein the outer end of the stub axle projects outwardly away from the outer end of the cartridge;

(c) forming a cylindrical mass of a sound-absorptive material

(d) positioning the cylindrical mass within the roller tube;

(e) securing a roller insert within the first and second open end portions of the conveyor roller tube such that the conveyor roller tube is rotatable with respect to the stub axles.

In the above method, the steps of forming a cylindrical mass of a sound-absorptive material and positioning the cylindrical mass within the roller tube may comprise molding the cylindrical mass and thereafter urging the cylindrical mass into the roller tube. Alternatively, the cylindrical mass may be molded within the roller tube, such that the roller tube acts as a mold.

### BRIEF DESCRIPTION OF THE DRAWINGS

The following detailed description will be more fully understood in view of the drawings in which:

FIG. 1 is a partial cross-section of a conveyor roller assembly according to one embodiment of the present invention;

FIG. 2 is a cross-sectional view of a conveyor roller assembly according to one embodiment of the present invention, wherein the axles are shown in partial cross-section and the center portion of the conveyor roller tube and the sound-absorptive material have been omitted;

FIG. 3 is a side view of a stub axle according to an embodiment of the present invention;

FIG. 4 is a cross-sectional view of a cartridge used in the conveyor roller insert of the embodiment shown in FIG. 2;

FIG. 5 is a cross-sectional view of a bearing retainer assembly used in the conveyor roller insert of the embodiment shown in FIG. 2;

FIG. 6 is an outer end view of a bushing used in the conveyor roller insert of the embodiment shown in FIG. 2;

FIG. 7 is a cross-sectional view of the bushing shown in FIG. 5, taken along the line 7-7 thereof;

FIG. 8 is an inner end view of the bushing of FIGS. 6 and 7;

FIG. 9 is a cross-sectional view of a conveyor roller insert according to another embodiment of the present invention, wherein the axle is shown in partial cross-section;

FIG. 10 is a partial cross-section of a tapered conveyor roller assembly according to another embodiment of the present invention; and

FIG. 11 is a partial cross-section of a crowned conveyor roller assembly according to another embodiment of the present invention.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

The present invention is directed to a conveyor roller assembly having reduced noise during use. In particular, the conveyor roller assembly according to the present invention uses a sound-absorptive material within the roller tube in order to significantly reduce noise during use. Applicant has found that conveyor roller noise can be significantly reduced by blocking the transmission and propagation of sound waves within the roller tube.

Although conveyor roller noise is typically a result of vibration of the axle within the mounting hole of the support frame, faulty or worn out bearings, and the like, Applicant has found that noise levels are significantly reduced by blocking the transmission of standing waves and harmonic waves which would otherwise travel along the length of the roller tube of the conveyor roller assembly. Since the roller tubes are typically made from a metal such as carbon steel or stainless steel, sound waves are easily transmitted through the length of the roller tube. In addition, Applicant has further found that sound waves also propagate transverse to the longitudinal axis of the roller tube, and noise levels can be further reduced by preventing such propagation.

In order to prevent such transmission and propagation of sound waves, a sound-absorptive material is located within the roller tube. In one embodiment, the conveyor roller assembly includes a pair of stub axles rotationally supported within opposite ends of the roller tube, and a sound-absorptive material located within the interior of the roller tube between the stub axles. The sound-absorptive material substantially fills the interior space of the roller tube between the stub axles, and exerts an outward force against the interior wall of the roller tube. The sound-absorptive material will block the transmission of standing waves and harmonic waves traveling along the roller tube in a direction parallel to the longitudinal axis thereof. By compressing the sound-absorptive material within the interior of the roller tube such that it exerts an outward force against the interior wall of the roller tube, it can be assured that the sound-absorptive material remains in positive contact with the interior wall of the roller tube around its entire circumference and entire length between the stub axles. In this manner, the sound-absorptive material will be in positive contact with the inside wall of the roller tube throughout the inner circumference of the roller tube, and will absorb and prevent the transmission of sound waves which would otherwise propagate in a direction transverse to the longitudinal axis of the tube roller.

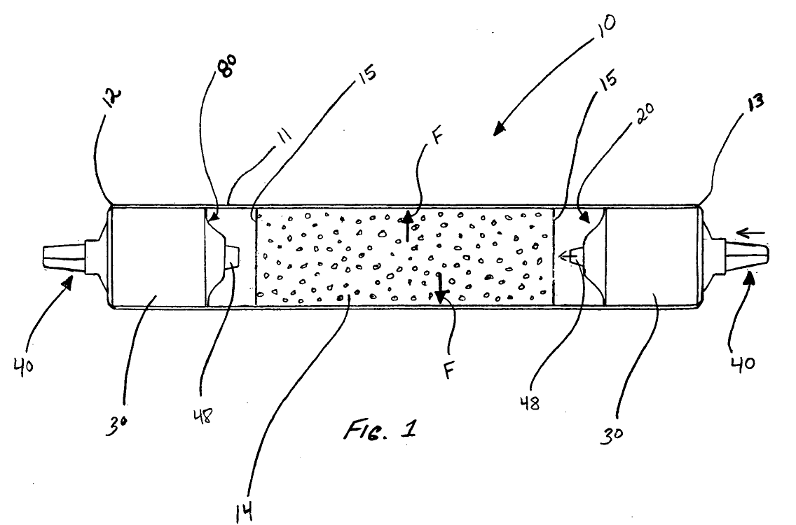

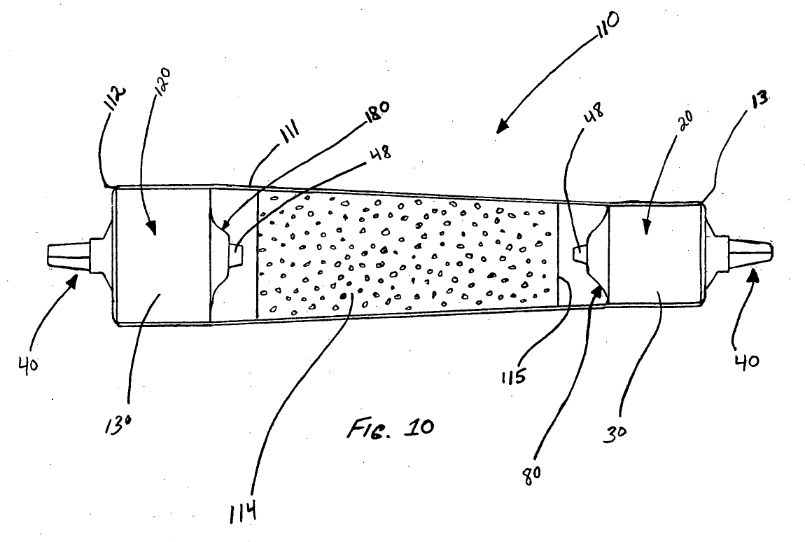

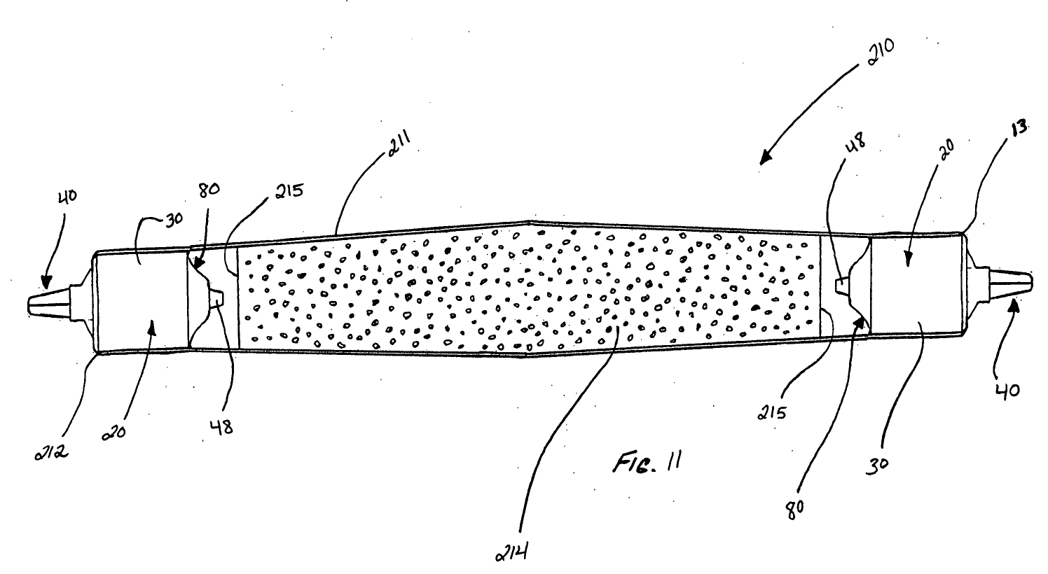

FIG. 1 depicts an exemplary embodiment of a conveyor roller assembly 10 according to one aspect of the present invention, wherein assembly 10 is depicted in partial cross-section. Conveyor roller assembly 10 generally includes a conveyor roller tube 11 having first and second open end portions 12 and 13. Conveyor roller tube 11 may be a straight cylinder as shown, or may even comprise a tapered cylinder, as shown in FIG. 10, or a crowned cylinder, as shown in FIG. 11. In addition, roller tube 1 may comprise a rigid, self-supported cylinder (either straight or tapered), and may be made from a metal such as carbon steel or stainless steel, or even a polymeric material such as polypropylene. Self-supporting means that roller tube 11 comprises a material of sufficient wall thickness so that no internal structural support is needed. In the exemplary embodiments shown, only a sound-absorptive material 14 is provided in the interior of roller tube 11 between the conveyor roller inserts 20 provided at each end of roller tube 11.

Conveyor roller inserts 20 having stub axles 40 rotatably mounted therein are secured within the first and second end portions of conveyor roller tube 11 such that conveyor roller tube 11 is rotatable relative to stub axles 40. As further described herein, stub axles 40 are also axially moveable with respect to conveyor roller tube 11 such that the outer end portion of stub axle 40 may be depressed inwardly (i.e., into the end portion of roller tube 11) for installation of the conveyor roller in a frame.

As further described herein, each conveyor roller insert 20 includes a tubular cartridge 30 which is shaped to be fitted into the open end portions 12 and 13 of conveyor roller tube 11. When mounted in the open end portion of conveyor roller tube 11, each cartridge 30 will be rotationally fixed with respect to roller tube 11. However, each stub axle 40 is rotatable with respect to cartridge 30, thus, allowing roller tube 11 to be rotatable with respect to stub axles 40. When the conveyor roller assembly 10 is mounted in a support frame, stub axles 40 will be rotationally fixed with respect to the mounting frame while roller tube 11 will be rotatable with respect to the mounting frame.

As also seen in the exemplary embodiment of FIG. 1, a sound-absorptive material 14 is located within the interior of roller tube 11, as shown. Sound-absorptive material 14 may comprise any of a variety of materials which tend to absorb rather than transmit sound waves there through. It is also desirable for sound-absorptive material 14 to have a low density and compressibility. Suitable materials include expanded polymers such as expanded polystyrene, particularly expanded polystyrene foam.

In general, sound-absorptive material 14 comprises a substantially cylindrical (e.g., straight, tapered or crowned) solid mass having end walls 15, wherein this solid mass is either formed in situ or which is inserted into the interior of roller tube 11. In the latter case, sound-absorptive material 14, as shown in FIG. 1, may comprise a cylindrical mass which substantially fills the interior of roller tube 11 between roller inserts 20 (e.g., between the inner ends 48 of stub axles 40).

Sound-absorptive material 14 may be compressed as it is inserted into roller tube 11 such that material 14 will exert an outward force F against the interior wall of roller tube 11 throughout the inner circumference of tube 11. This ensures that all or substantially all of the entire outer surface of the cylindrical mass comprising sound-absorptive material 14 will be in positive contact with the inside wall of roller tube 11. In this manner, sound-absorptive material 14 will absorb sound which would otherwise propagate transversely to the longitudinal axis of roller tube 11. In addition, sound waves traveling along roller tube 11 in the longitudinal direction, including both standing waves and harmonic waves, will also be absorbed by sound-absorptive material 14, particularly when the sound-absorptive material is compressed within the roller tube 11. In order to simplify fabrication, end walls 15 may substantially flat—i.e., end walls 15 may extend substantially perpendicular to the longitudinal axis of the solid cylindrical mass of sound-absorptive material 14.

In the embodiment of FIG. 1, it will also be noted that sound-absorptive material 14 is positioned within roller tube 11 such that a small space is provided between the end walls 15 of sound-absorptive material 14 and the inner ends of roller inserts 20. In general, sound-absorptive material 14 should extend as near as possible to the inner ends of roller inserts 20 without contacting any portion of roller inserts 20 with respect to which roller tube 11 rotates during use. In the exemplary embodiment shown, the length of sound-absorptive material 14 and its positioning within roller tube 11 are such that a small space is provided between the end walls 15 of sound-absorptive material 14 and the inner ends 48 of stub axles 40, thereby ensuring that sound-absorptive material 14 will not interfere with the rotation of roller tube 11 with respect to stub axles 40 (i.e., sound-absorptive material 14 will not rub against stub axles 40 during use). Since sound-absorptive material 14 is compressed within roller tube 11 and exerts an outward force against the interior wall of roller tube 11, sound-absorptive material 14 is not rotatable with respect to roller tube 11. Thus, sound-absorptive material 14 will rotate with respect to stub axles 40 during use.

As mentioned previously, the solid mass comprising sound-absorptive material 14 may be formed separately from the conveyor roller assembly or formed in situ. In the former case, a solid cylinder of sound-absorptive material 14 may be formed, such as by injection molding. The outer diameter of this cylindrical mass may be equal to or greater than the interior diameter of roller tube 11. When the outer diameter is greater than the interior diameter of roller tube 11, sound-absorptive material 14 is forced into roller tube 11 such that it exerts an outward force against the interior wall of roller tube 11. During assembly, the sound-absorptive material 14 may be pushed into roller tube 11, and then roller inserts 20 secured within the first and second end portions of conveyor roller tube 11 in the usual fashion (such as described in U.S. Pat. No. 5,865,290, or in applicant's U.S. patent application Ser. No. 10/817,185, filed Apr. 2, 2004). Alternatively, one of the roller inserts 20 may first be secured within one of the end portions of roller tube 11, sound-absorptive material 14 then pressed into roller tube 11, and finally the second roller insert 20 secured within the open end portion of roller tube 11.

Sound-absorptive material 14 may also be formed in situ. In particular, a polymeric material, such as polystyrene, may be injected into the interior of roller tube 11 under suitable conditions to form sound-absorptive material 14 comprising an expanded polymeric foam (such as EPS foam). In essence, the interior of roller tube 11 acts as the mold for forming sound-absorptive material 14. The formation of expanded polymeric articles using a mold is well-known to those skilled in the art. When sound-absorptive material 14 is formed in situ using roller tube 11 as a mold, one or both of roller inserts 20 may be secured within the first and second end portions of conveyor roller tube 11 after molding of sound-absorptive material 14. Such an assembly sequence will help ensure that sound-absorptive material 14 will not rub against any portion of roller inserts 20 during use (e.g., a space will be provided between sound-absorptive material 14 and the inner ends 48 of stub axles 40).

In the alternative embodiment shown in FIG. 10 wherein like numerals indicate elements similar to those shown in FIGS. 1-9, a tapered conveyor roller assembly 110 is provided. In this embodiment, roller tube 111 comprises a tapered cylinder, at least in the region located between roller inserts 20 and 120. Sound-absorptive material 114 in FIG. 10 comprises a tapered cylindrical mass which substantially fills the entire interior of roller tube 11 between roller inserts 20 and 120. As was the case with the exemplary embodiment shown in FIG. 1, the tapered cylinder comprising sound-absorptive material 114 may be configured and positioned such that a small space is provided between the ends of sound-absorptive material 114 and the inner ends of roller inserts 20 and 120. Sound-absorptive material 114 may be formed apart from the conveyor roller assembly as a tapered cylindrical mass and then merely pressed into the interior of roller tube 11, or it may be formed in situ, as described previously. In the former case, the smaller diameter end of sound-absorptive material 114 would be inserted into the larger diameter open end portion 112 of roller tube 111.

It will be understood that tapered conveyor rollers may be formed in a variety of manners known to those skilled in the art. Therefore, the tapered conveyor roller shown in FIG. 10 is merely exemplary of one embodiment of a tapered roller according to the present invention.

FIG. 11 depicts yet another alternative embodiment wherein a crowned conveyor roller assembly 210 is provided, wherein like numerals indicate elements similar to those shown in FIGS. 1-10 herein. In the embodiment of FIG. 11, roller tube 211 comprises a crowned cylinder which is tapered at least in the region located between roller inserts 20. However, in contrast to the tapered conveyor roller assembly in FIG. 10, crowned roller tube 211 tapers in both directions from the center of roller tube 211. It will be understood, however, that the configuration of crowned roller tube 211 shown in FIG. 11 is merely exemplary. For example, crowned roller tube 211 may be configured such that the diameter of tube 211 is greatest at a point other than the center of the tube. Sound-absorptive material 214 in FIG. 11 comprises a crowned cylindrical mass which substantially fills the entire interior of roller tube 211 between roller inserts 20. As was the case with exemplary embodiment shown in FIG. 1, the crowned cylinder comprising sound-absorptive material 214 may be configured and positioned such that a small space is provided between the ends of sound-absorptive material 214 and the inner ends of roller inserts 20.

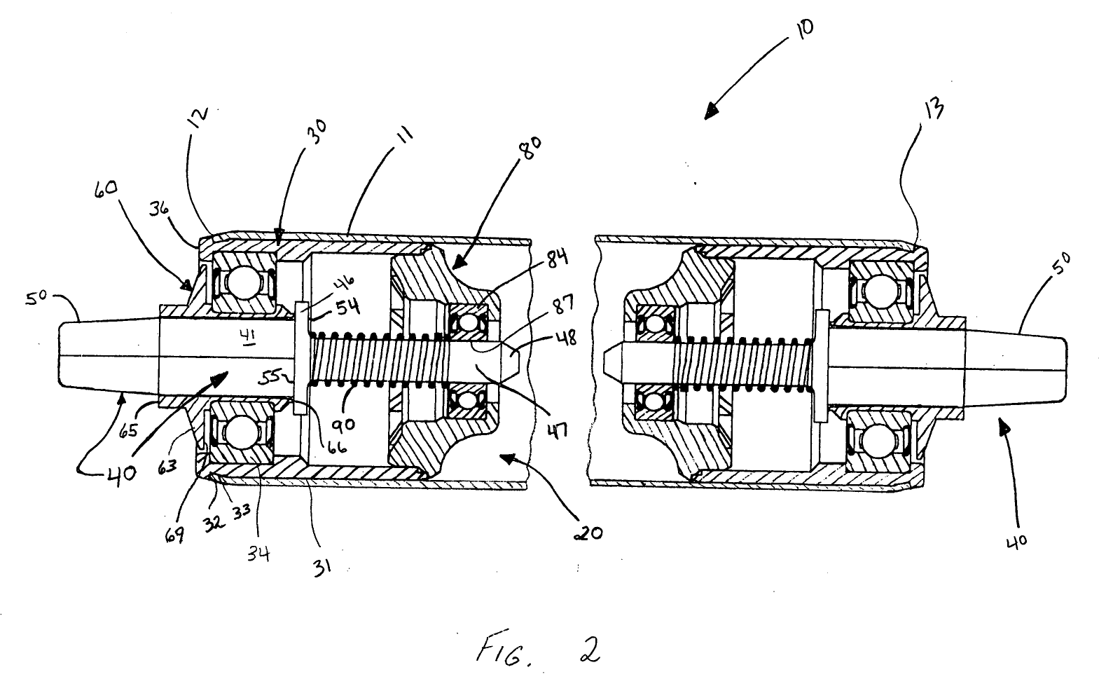

FIGS. 2-9, in conjunction with the description provided below, provide additional details regarding one embodiment of roller inserts 20. It should be noted, however, that the sound-absorptive material has been omitted from these figures, particularly FIG. 2, for purposes of clarity.

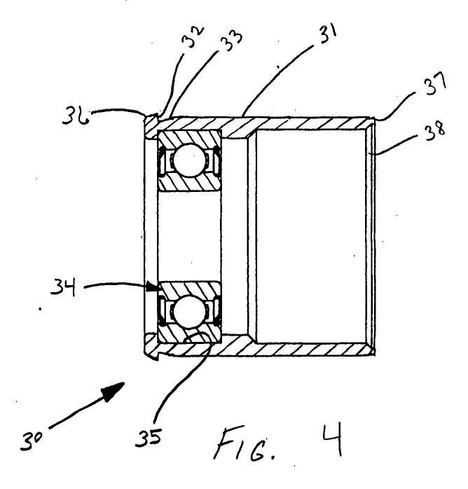

In the embodiment of FIG. 2, conveyor roller insert 20 includes a tubular cartridge 30 shaped to be fitted into the open end portions 12 and 13 of conveyor roller tube 11. Cartridge 30 includes a generally cylindrical sidewall 31, and inner and outer ends 37 and 36, respectively (see FIGS. 2 and 4). Outer end 36 includes a lip 32 formed thereon which is configured to engage and cover the end wall of conveyor roller tube 11. In this manner, cartridge 30 may be press fit into the open end portions of conveyor roller tube 11.

In the embodiment shown in FIGS. 2 and 4, sidewall 31 tapers inwardly adjacent lip 32 such that the open end portion of tube 11 may be crimped into the tapered groove formed by lip 32 and tapered portion 33 of sidewall 31, as shown in FIG. 2. As best seen in the cross-sectional view of FIG. 4, cartridge 30 may also include a sloped shoulder 38 extending about the interior periphery adjacent inner end 37. As further described herein, sloped shoulder 38 facilitates the attachment of a bearing retainer member 80 to the inner end 37 of cartridge 30.

As best seen in FIG. 4, cartridge 30 further includes a bearing 34 having inner and outer races and a ring of balls captured therebetween. The outer race of bearing 34 is seated and captured within a groove 35 formed in the interior of sidewall 31 of cartridge 30 adjacent outer end 36. Since cartridge 30 may be made from a polymeric material, particularly an electrically conductive thermoplastic (such as electrically conductive polypropylene), cartridge 30 may be molded around bearing 34 in order to encapsulate and retain bearing 34 within cartridge 30.

As best seen in FIG. 2, stub axle 40 extends through the central passageway formed by the inner race of bearing 34 such that bearing 34 supports stub axle 40 and allows for the rotation of cartridge 30 with respect to axle 40. In the embodiment shown in FIG. 2, however, a bushing 60 is provided between stub axle 40 and bearing 34, as further described herein.

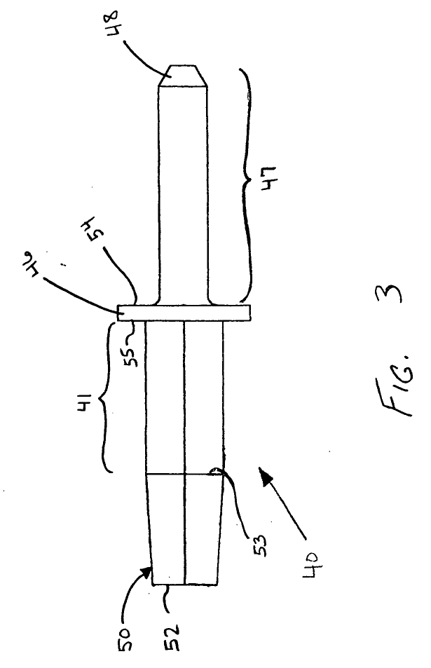

An axle according to one embodiment of the present invention is depicted in FIG. 3, specifically, a stub axle 40. Stub axle 40 includes an elongate body portion 41 and a tapered tip (or outer end) portion 50 extending outwardly away from body portion 41. Elongate body portion 41 and tip portion 50 may have hexagonal cross-sectional shapes, as shown. In this manner, axle 40 is configured for use with a support frame having hexagonal openings for receiving tip portion 50 of axle 40. Of course, the present invention is not limited to such axles, as axle 40, particularly, tip portion 50, may alternatively have a cylindrical or other polygonal cross-sectional shape.

If desired, axle 40 may be configured in the manner described in detail in applicant's U.S. patent application Ser. No. 10/817,185, filed Apr. 2, 2004. In particular, a polymeric end cap may be provided, as described in this pending application, in order to provide further reduced vibration, noise and frame wear. In the embodiment depicted in the present application, however, axle 40 may be integrally formed from a metal (such as steel).

In the embodiment shown in FIG. 3, tip portion 50 of axle 40 tapers inwardly such that the diameter of tip portion 50 at distal end 52 is smaller than the diameter at proximal end 53. In the alternative embodiment of FIG. 9, tip portion 150 has a straight cylindrical shape rather than tapered. The remaining portions of roller insert 20 in FIG. 9, are identical to that shown in FIG. 2.

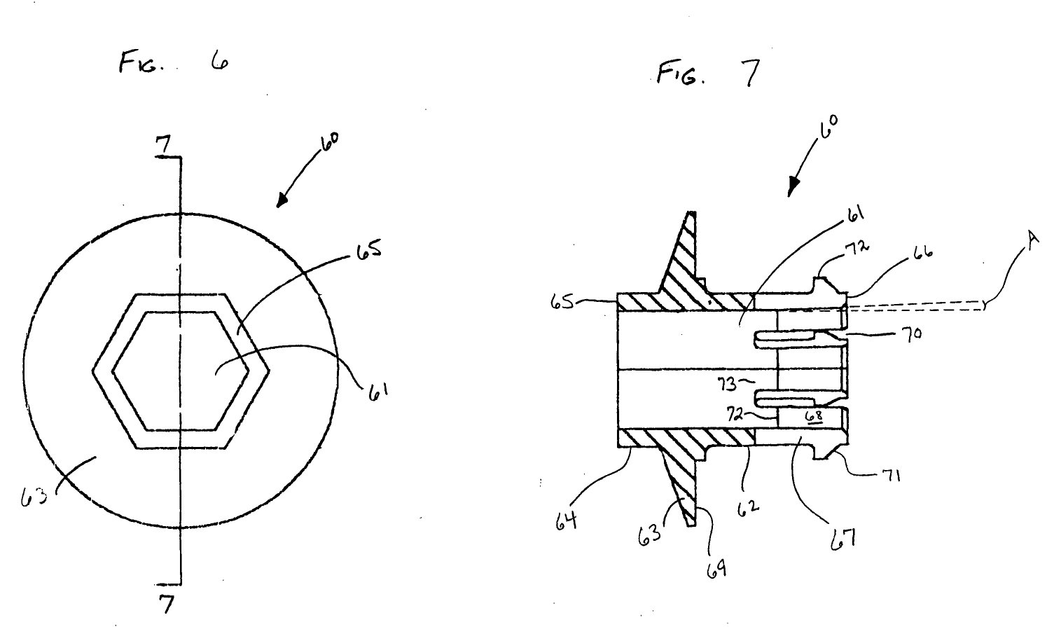

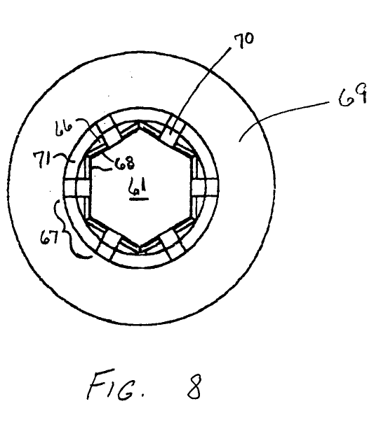

As mentioned previously, a bushing 60 may be positioned within bearing 54, as seen in FIG. 2. As shown in FIGS. 6 and 7, bushing 60 includes a central bore 61 which is shaped to slidably receive elongate body portion 41 of stub axle 40 therethrough. Thus, in the embodiment shown, central bore 60 has a hexagonal cross-sectional shape corresponding to that of body portion 41 of axle 40. In this manner, elongate body portion 41 of axle 40 may be positioned within central bore 61 of bushing 60 such that axle 40 is not capable of rotation with respect to bushing 60. However, axle 40 will be rotatable, along with bushing 60, with respect to cartridge 30 and conveyor roller tube 11.

Bushing 60 also includes a circumferential groove 62 extending about its outer surface, wherein groove 62 is sized and configured such that the inner race of bearing 34 may be at least partially positioned within the groove 62 (see FIG. 2). When positioned in this manner, the inner race of bearing 34 will essentially be attached to bushing 60 such that cartridge 30 is rotatable with respect to bushing 60.

Bushing 60 may further include a flange 63 located distally with respect to groove 62. Flange 63 is configured to cover and protect bearing 34, and may have an outer diameter slightly less than the inner diameter of outer end 36 of cartridge 30. In this manner, flange 63 will not interfere with the rotation of cartridge 30 with respect to bushing 60 and axle 40. In addition, as best seen in FIG. 7, flange 63 may be slightly spaced distally (i.e., axially to the left in FIG. 7) from groove 62 such that, when bushing 60 is installed as shown in FIG. 2, a slight gap will exist between inner surface 69 of flange 63 and bearing 34. As also seen in FIG. 7, bushing 60 may further include an extension 64 located between distal end surface 65 and flange 63. Extension 64 will provide additional support for axle 40, and its outer surface may have a hexagonal cross-sectional shape corresponding to the hexagonal shape of central bore 61.

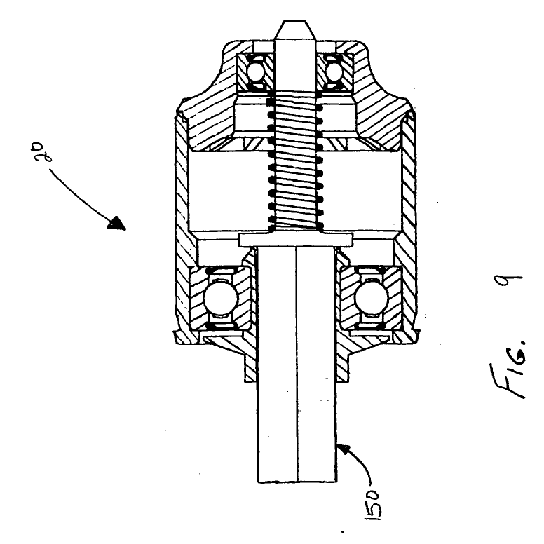

At its proximal end, bushing 60 is slotted such that a plurality of fingers 67 are provided. In particular, as best seen in FIGS. 7 and 8, a plurality of grooves 70 extend from proximal end 66 of bushing 60 in the axial direction. With respect to hexagonal central bore 61, grooves 70 are located on the flat portion of the hexagonal cross-section. In this manner, six fingers 67 are provided. When viewed in cross-section, the outer surface of each finger 67 will comprise a circular segment. The cross-sectional shape of the inner surface 68 of each finger 67 will be angular in nature, as best seen in the end view of FIG. 8.

In the embodiment shown in FIGS. 6-8, grooves 70 extend beyond the midpoint of outer circumferential groove 62. In addition, at least a portion of the inner surface 68 of fingers 67 taper outwardly, as indicated by angle A in FIG. 7. In the embodiment shown, inner surface 68 is not tapered along the entire length of each finger 67. In particular, inner surface 68 of finger 67, when viewed in the axial cross-section of FIG. 7, tapers outwardly from a line 72 spaced away from the base 73 of finger 67. In this manner, each finger 67 is cantilevered from line 72. In other words, each finger 67 includes a base portion having a non-tapered inner surface, and a cantilevered portion having a tapered inner surface.

Because the inner surface 68 of fingers 67 taper outwardly, a force applied axially against proximal end surface 66 of bushing 60 will cause fingers 67 to flex outwardly. For example, and as further described herein, axle 40 may include a flange 46 positioned such that flange 46 is biased against proximal end surface 66 of bushing 60. As fingers 67 of bushing 60 are urged outwardly, projections 72 which define the proximal end wall of groove 62 on bushing 60 will prevent bushing 60 from being forced out of roller insert 20. As also seen in FIG. 7, the proximal end wall 71 of projections 72 may be tapered in order to facilitate the insertion of bushing 60 into roller insert 20.

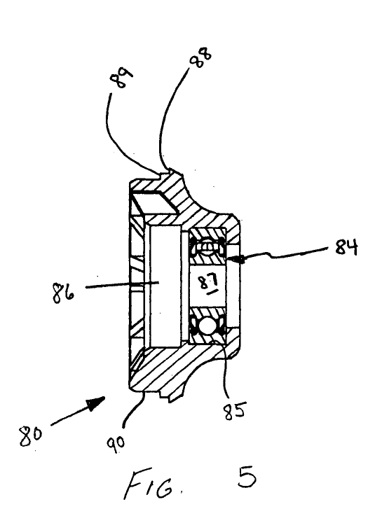

In the embodiment shown in FIG. 2, each roller insert may further include a second bearing 84 for further rotationally supporting axle 40 with respect to conveyor roller tube 11. In particular, and as best seen in FIG. 5, second bearing 84 is provided in a bearing retainer assembly 80.

Bearing retainer assembly 80 is generally tubular in nature, and includes a central passageway 86. The outer race of bearing 84 is seated and captured within a groove 85 formed in the interior side wall of bearing retainer member 80, as shown in FIG. 5. Like cartridge 30, bearing retainer assembly 80 may be made from a polymeric material, particularly an electrically conductive thermoplastic such as electrically conductive polypropylene. Therefore, bearing retainer assembly 80 may be molded around bearing 84 in order to encapsulate and retain bearing 84 therein. The inner race of bearing 84 defines a central passageway 87 which is sized and configured to slidingly receive and support a rod portion 47 provided an axle 40, as further described herein.

On its outer surface, bearing retainer assembly 80 includes an outer lip 88 extending about the outer circumference of bearing retaining assembly 80. Outer lip 88 is sized and configured such that bearing retainer assembly 80 may be inserted into the inner end portion of cartridge 30 with lip 88 seated against inner end wall 37 of cartridge 30. A shoulder 89 is also provided, and is spaced distally from lip 88. When bearing retainer assembly 80 is inserted into the inner end portion of cartridge 30, shoulder 89 will abut against sloped shoulder 38 on cartridge 30. This configuration will facilitate the welding (such as by sonic welding) of bearing retainer assembly 80 to the inner end portion of cartridge 30. Furthermore, bearing retainer assembly 80 includes a distal end portion 90 having a cylindrical outer surface. Distal end portion 90 is sized and configured to be snugly received into the inner end portion of cartridge 30, as shown in FIG. 2. It should also be noted that the outer circumference of bearing retainer assembly 80 at lip 88 may be equal to or slightly less than the outer circumference of cartridge 30 at inner end wall 37.

As further seen in FIG. 3, stub axle 40 may include a rod portion 47 extending away from elongate body portion 41 at the proximal end thereof. The proximal or inner end 48 of rod portion 47 may also be tapered as shown in order to facilitate insertion of rod portion 47 into central passageway 87 formed by the inner race of second bearing 84. Rod portion 47 is sized and configured to be slidably received in central passageway 87. In this manner, the inner race of second bearing 84 will support rod portion 47 while still allowing slidable movement of the axle relative to both first bearing 34 and second bearing 84. Second bearing 84 will also facilitate rotational movement of cartridge 30 relative to axle 40.

As mentioned previously, axle 40 may be biased outwardly from cartridge 30 such that the outer end portion of the axle will project outwardly from outer end 36 of cartridge 30. However, the outer end portion of the axle can be urged inwardly in order to facilitate insertion of the outer end portion of the axle into a mounting hole on a conveyor frame.

In the embodiment shown, axle 40 further includes a flange 46 located between elongate body portion 41 and rod portion 47. In the embodiment shown, flange 46 may be any of a variety of shapes. However, the outer diameter of flange 46 should be greater than the outer diameter of bushing 60 at proximal end surface 66. In the exemplary embodiment shown, flange 46 has a circular cross-sectional shape.

As best seen in FIG. 2, flange 46, specifically the proximal or inner surface 54 of flange 46, provides a seat for a biasing member, such as a coil spring 90. Coil spring 90 encircles rod portion 47 of axle 40, and is seated against the inner race of second bearing 84. In this manner, coil spring 90 will bias axle 40 outwardly (i.e., in the distal direction). Outer or distal end surface 55 of flange 46 is urged against proximal end surface 66 of bushing 60 by coil spring 90. Thus, bushing 60 acts as a limit or stop, preventing the outward travel of axle 40 from cartridge 30 beyond a preselected distance. At the same time, flange 46 will cause fingers 67 of busing 60 to flex outwardly, thereby preventing bushing 60 from being forced out of cartridge 30.

In the embodiment shown in FIG. 2, the conveyor roller insert 20 is configured such that axle 40 is biased outwardly to the extent that shoulder 45 is normally approximately aligned with distal end surface 65 of bushing 60. In this manner, only tip portion 50 of axle 40 is exposed. The outer end or tip portion 50 of axle 40 may be urged inwardly into bushing 60. When mounted in a conveyor frame, bushing 60 will not enter the mounting hole on the frame. Therefore, the outer end portion of axle 40 need not be urged inwardly beyond distal end surface 65 of bushing 60.

All of the components of conveyor roller insert 20 may be made from electrically conductive materials. For example, axle 40 may be made from a metal such as steel. Cartridge 30, bushing 60 and bearing retainer assembly 80 may also be made from an electrically conductive polymeric material (e.g., electrically conductive, glass-reinforced polypropylene). Of course any of a variety of other materials may be used for each of these components.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What I claim is:

1. A conveyor roller assembly comprising:
(a) an elongate roller tube;
(b) a pair of stub axles rotationally supported within opposite ends of said roller tube such that said roller tube is rotatable with respect to said stub axles, each of said stub axles having outer and inner ends; and
(c) a sound-absorptive material located within said roller tube.

2. The conveyor roller assembly of claim 1, wherein said roller tube comprises a rigid, self-supporting cylinder.

3. The conveyor roller assembly of claim 2, wherein at least a portion of said roller is tapered.

4. The conveyor roller assembly of claim 3, wherein said roller tube is crowned.

5. The conveyor roller assembly of claim 2, wherein said roller tube comprises a straight cylinder.

6. The conveyor roller assembly of claim 1, wherein each of said stub axles is provided as part of a roller insert, said roller inserts inserted into opposite ends of said roller tube, each of said roller inserts further comprising:
(a) a cartridge having inner and outer ends and configured to be inserted into an end of a conveyor roller tube, wherein one of said stub axles is positioned within said cartridge; and
(c) at least one bearing mounted within said cartridge and supporting said axle such that said cartridge is rotatable with respect to said axle and said axle is slidable with respect to said at least one bearing;
wherein the outer end of each of said stub axles projects outwardly away from the outer end of its corresponding cartridge, and further wherein at least one of said axles is biased outwardly from its corresponding cartridge.

7. The conveyor roller assembly of claim 1, wherein the interior of said roller tube between the inner ends of said stub axles is substantially filled by said sound-absorptive material.

8. The conveyor roller assembly of claim 1, wherein said sound-absorptive material comprises a cylindrical mass having an outer diameter which is equal to or greater than the interior diameter of said roller tube.

9. The conveyor roller assembly of claim 8, wherein said cylindrical mass is compressed within said roller tube such that said cylindrical mass exerts an outward force against the interior wall of said roller tube.

10. The conveyor roller assembly of claim 6, wherein said sound-absorptive material comprises a cylindrical mass having a pair of opposed end walls, and the interior of said roller tube between said roller inserts substantially filled by said sound-absorptive material such that the end walls of said cylindrical mass are immediately adjacent to the innermost portion of said roller inserts.

11. The conveyor roller assembly of claim 10, wherein the end walls of said cylindrical mass are immediately adjacent to the inner ends of said stub axles.

12. The conveyor roller assembly of claim 10, wherein said sound-absorptive material comprises a tapered cylindrical mass.

13. A conveyor roller assembly comprising:
(a) an elongate roller tube comprising a rigid, self-supporting cylinder;
(b) a pair of roller inserts inserted into opposite ends of said roller tube, each of said roller inserts comprising:
a stub axle having inner and outer ends;
a cartridge having inner and outer ends, said stub axle positioned within said cartridge; and
at least one bearing mounted within said cartridge and supporting said axle such that said cartridge is rotatable with respect to said axle;
wherein the outer end of said stub axle projects outwardly away from the outer end of said cartridge; and
(c) a sound-absorptive material located within said roller tube, said sound-absorptive material comprising a cylindrical mass compressed within said roller tube such that said cylindrical mass exerts an outward force against the interior wall of said roller tube;
wherein said cartridges are inserted into opposite ends of said conveyor roller tube such that said roller tube is rotatable with respect to said stub axles, and further wherein said sound-absorptive material rotates with said conveyor roller tube during use.

14. The conveyor roller assembly of claim 13, wherein said sound-absorptive material comprises expanded polystyrene foam.

15. A method of forming a conveyor roller assembly, comprising:
(a) providing an elongate roller tube comprising a rigid, self-supporting cylinder having first and second open end portions;
(b) providing a pair of roller inserts, each of said roller inserts comprising:
a stub axle having inner and outer ends;
a cartridge having inner and outer ends, said stub axle positioned within said cartridge; and
at least one bearing mounted within said cartridge and supporting said axle such that said cartridge is rotatable with respect to said axle;
wherein the outer end of said stub axle projects outwardly away from the outer end of said cartridge;
(c) forming a cylindrical mass of a sound-absorptive material
(d) positioning said cylindrical mass within said roller tube;
(e) securing a roller insert within said first and second open end portions of said conveyor roller tube such that the conveyor roller tube is rotatable with respect to said stub axles.

16. The method of claim 15, wherein said steps of forming a cylindrical mass of a sound-absorptive material and positioning said cylindrical mass within said roller tube comprise molding said cylindrical mass and thereafter urging said cylindrical mass into said roller tube.

17. The method of claim 15, wherein said steps of forming a cylindrical mass of a sound-absorptive material and positioning said cylindrical mass within said roller tube are performed simultaneously by molding said cylindrical mass within said roller tube, wherein said roller tube acts as a mold.
